(19) United States
(12) Patent Application Publication
(10) Pub. No.: US 2003/0028577 A1
(43) Pub. Date: Feb. 6, 2003

(54) HTTP distributed XML-based automated event polling for network and E-service management

(76) Inventors: Chia-Chu Dorland, Fort Collins, CO (US); Aaron Loyd, Fort Collins, CO (US); Michael Haeuptle, Roseville, CA (US)

Correspondence Address: HEWETT-PACKARD COMPANY, Intellectual Property Administration, P.O. Box 272400, Fort Collins, CO, 80527-2400, US

(21) Appl. No.: 09/843,945

(22) Filed: Apr. 30, 2001

(51) Int. Cl. G06F 9/00; G06F 15/16

(52) U.S. Cl. 709/100; 709/200

(57) ABSTRACT

A method and system is disclosed for automated event polling in a network. A server receives a HTTP request for data from a database on the server. A client generates the HTTP request for the data. The server responds to the request by reformatting the data into an XML format. The server then transmits the data in XML format to the client. The client receives the data transmitted from the server in XML format and converts the data in XML format to a format used by the client software.

### BACKGROUND OF THE INVENTION

1. Field of the Invention

The present invention relates to network management systems, and in particular to automated event polling.

2. Background Information

As technology continues to develop and be deployed to an increasing number of users and applications, networks become larger and more complex. Consequently, network management involves monitoring of the deployed nodes (i.e, computers, servers, routers, sub-networks, network enabled devices, and the like). The monitoring process includes a variety of parameters that are important to the system manager and the health of the network.

One part of the monitoring performed by a client network management systems is to track events (e.g., Service Level Objectives (SLO) violations, configuration changes, state information, and the like) that occur on remote Application Servers. It is important for the client to know when certain events have occurred at the various Application Servers in the network. This information can be even more valuable for monitoring internet Application Servers having E-services as these servers can be used in conducting business transactions. The terms events, data and event data are used interchangeably throughout this document to indicate the information that is logged into a database by a server to record various operating parameters.

Prior systems have relied on Simple Network Message Protocol (SNMP) traps to obtain this information. Additionally, re-sending active events periodically or querying the event polling engine residing on the Application Server to determine an E-service's proper status have been proposed. However, these solutions lack reliability because data or events are lost if the client is not online to receive them in at the time the data or events are generated and transmitted. Prior systems have had the client as a passive listener, waiting for notification of events to be sent out by the server. If the client was offline and an event notification was sent before the client came back online, it would be lost. Because events often contain state information, clients would display incorrect status due to lost events. Also, the response was formatted differently to suit different client applications, in prior systems. Therefore, compatibility between different client applications was limited.

Therefore, it would be desirable to provide a system that enables the client to avoid losing event data stored in remote event databases. Further, it would be desirable to provide a common platform to all client applications to receive the events/data in a universal language.

### SUMMARY OF THE INVENTION

The present invention is directed to methods and systems for automated event polling in a network. An exemplary method comprises logging data into a database on a server, receiving a request for the data generated by a client using a HTTP message, responding to the request by reformatting the data into an Extensible Markup Language (XML) format, and transmitting the data in XML format to the client.

An exemplary method of event polling in a network on a client comprises generating a HTTP request for data from a database on a server, receiving a response to the request in XML format, and converting the data in XML format to a format used by client software.

An exemplary system for automated event polling in a network comprises a computer-based server and a computer-based client. The computer-based server comprises logic that receives a HTTP request for data from a database on the server, logic that responds to the request by reformatting the data into an XML format, and logic that transmits the data in XML format. The computer-based client comprises logic that generates the HTTP request for the data from the database on the server, logic that receives the data transmitted from the server in XML format, and logic that converts the data in XML format to a format used by client software.

### BRIEF DESCRIPTION OF THE DRAWINGS

The above features and advantages of the invention, and additional features and advantages of the invention, will be better appreciated from the following, wherein like elements in the drawings will have the same reference number detailed description of the invention made with reference to the drawings, and wherein:

FIG. 1 shows a flow chart of an exemplary method of the present invention;

FIG. 2 shows a flow chart of an alternative method of the present invention;

FIG. 3 shows a block diagram of an exemplary system of the present invention;

FIG. 4 shows a flow chart for synchronization of a client;

FIG. 5 shows a block diagram of another exemplary system of the present invention; and

FIG. 6 shows an screen display of event data of the present invention.

### DETAILED DESCRIPTION OF THE PREFERRED EMBODIMENTS

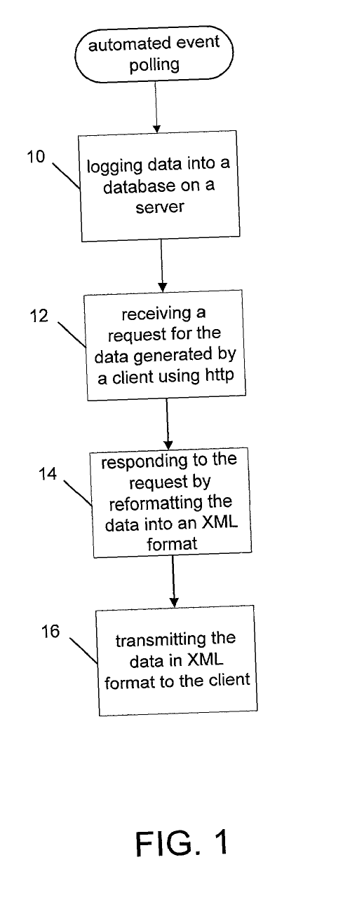

FIG. 1 is a flow chart of an exemplary method of providing automated event polling. The process begins by logging data into a database on a server, in step 10. For example, event data associated with the server can be logged for retrieval by a client application. In step 12, a request is received for the data from a client using a Hypertext Transfer Protocol (HTTP) message. In step 14, the request is responded to by reformatting the requested data into an XML format. The data in XML format is then transmitted to the client, in step 16.

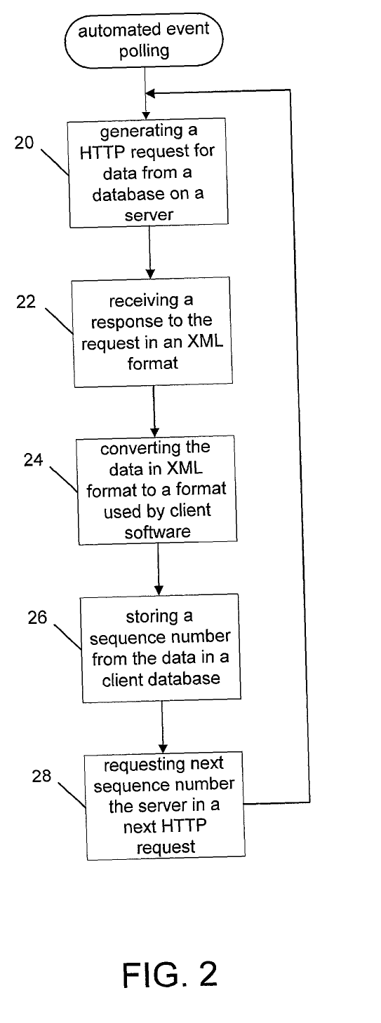

Referring to FIG. 2, another exemplary method of automated event polling in a network on a client platform is shown. The process starts by generating a HTTP request for data from a database on a server, in step 20. In step 22, a response to the request is received in XML format. The data in XML format is converted to a format used by client software, in step 24. In step 26, a sequence number from the data is stored in a client database. In step 28, data that corresponds to a next sequence number is requested from the database on the server in a next HTTP request. The process loops to the start and continually repeats itself. Thus, by indexing the sequence number, the client only requests the data (e.g., alarms, status information, and the like) it has not already processed. Additionally, if the connection between the client and the server is interrupted, the client can recover event data that was logged to the server database during the interruption.

To facilitate an understanding of the invention, many aspects of the invention are described in terms of sequences of actions to be performed by elements of a computer-based system. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of a computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of an embodiment may be referred to herein as “logic that” performs a described action.

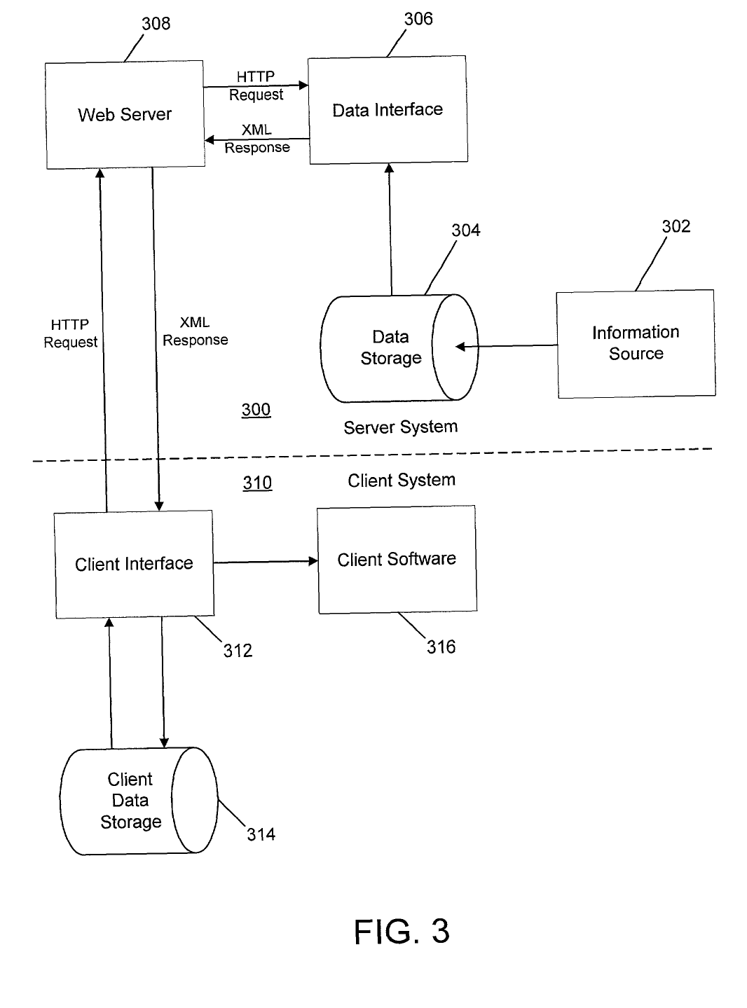

FIG. 3 shows a block diagram of an exemplary system for providing automated event polling. The system comprises a computer-based server and a computer-based client. The computer-based server 300 includes logic that receives a HTTP request (e.g., web server 308) for data from a database 304 on the server 300. The computer-based server 300 also includes logic that responds to the request (e.g., data interface 306) by reformatting the data into an XML format and logic that transmits the data in XML format. A computer-based client 310 includes logic that generates the HTTP request (e.g., client interface 312) for the data from the database 304 on the server 300. The computer-based client 310 also includes logic that receives the data (e.g., client interface 312) transmitted from the server 300 in an XML format and logic that converts the data in XML format to a format used by client software 316.

An information source 302 provides event data to a database 304. The database 304 is accessed by a data interface 306 to retrieve the event data. The data interface 306 is controlled by web server 308. Web server 308 accesses data interface 306 at the request of client interface 312. Because the data event retrieval is performed at the request of a client system via client interface 312, the client interface 312 generates the request messages as shown in FIG. 3. Specifically, the client interface 312 generates a HTTP request that is transmitted to web server 308. Web server 308 passes the HTTP request to data interface 306. The data interface 306 retrieves the requested data events from database 304. The data interface 306 reformats the event data into Extensible Markup Language (XML) format. The data interface 306 can be implemented in any appropriate manner, such as Common Gateway Interface (CGI), Java Servlet, Microsoft Internet Server Application Programming Interface (ISAPI), and the like. The data interface 306 routes the XML response (i.e., the event data reformatted in XML) to web server 308. Web server 308 routes the XML response to client interface 312. Client interface 312 converts the XML response into a format usable by client software 316.

In addition to automatically polling for events and converting the data as describe above, the client interface 312 also stores a sequence number and time-stamp information of the previous response in client database 314. The sequence number and time-stamp information are associated with the event data to uniquely identify the event data. Therefore, client interface 312 can recover event data that has been logged since the client last accessed the database 302. For example, in the event of a crash of the client system, the client interface 312 can recover any event data that was logged while the client system was down. Additionally, the previous request's sequence number and time-stamp can be used by the client interface 312 to detect problems on the server side, such as a reinitialization (e.g., a re-install of the software) of database 304. A reinitialization can be detected because the client interface 312 compares the sequence number and time-stamp in client database 314 to the sequence number and time-stamp of the XML response.

When the server database 304 is reinitialized, or when the client is accessing database 304 for the first time, the client can synchronize with the server database 304. The client 310 can synchronize with the server 300 to ensure that only data (e.g., an alarm) that has not been processed by the client 310 is retrieved. The client 310 can use the sequence number to filter out the data it has already processed. The sequence number is incremented for each time an event is accessed. The client 310 saves the highest sequence number it received to its database 314. This ensures that the client 310 can re-synchronize where it left off, if the client 310 is implemented as a process that can be re-started. In case the server 300 resets its database 304 (e.g., server re-installation, sequence number range exhausted, and the like), a new time-stamp and sequence number is set in an appropriate field in the database 304. Following is an example in pseudo code to accomplish the synchronization task.

if sn and tc not present in database

prev_sn = 0
prev_tc = 0

else

prev_sn = <sn from database>
prev_tc = <tc from database>

endif
download and parse events
curr_sn = <maximum sn from all parsed event tags>
curr_tc = <tc from parsed event attributes>
if(curr_tc != prev_tc)

prev_sn = 0
prev_tc = curr_tc

endif
for all parsed event tags

if(sn in event tag >= prev_sn)

process event

endif

done
save curr_sn+1 and curr_tc to client database

In the above pseudo code, tc is the time-stamp of the database creation, sn is the sequence number of the event, curr_is current, and prev_is previous.

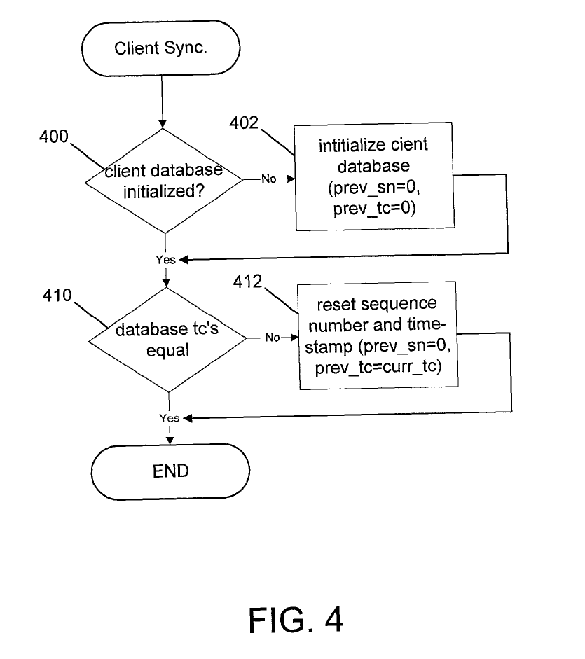

FIG. 4 shows a flowchart of a client synchronization process. The client is synchronized when a received database creation time stamp does not equal a stored database creation time stamp stored in the client database or when the client database has not been initialized. The client database is checked to see if it is initialized, in step 400. If the client database is not initialized, then the sequence number and the server database creation time-stamp stored in the client database are set to zero, in step 402. In step 410, the server database creation time-stamp is comparing to a creation time-stamp stored in the client database. If the creation time-stamps are not equal (e.g., the server software has been reinstalled), then the sequence number is set to zero and the creation time-stamp stored in the client database is set to the server database creation time-stamp, in step 412. When the database is initialized, the time-stamps will not be equal, so the process will be the same as if the server had been reinitialized. In both cases the sequence number is set to zero, therefore all data events on the server database will be requested because all data events will have a sequence number greater than zero.

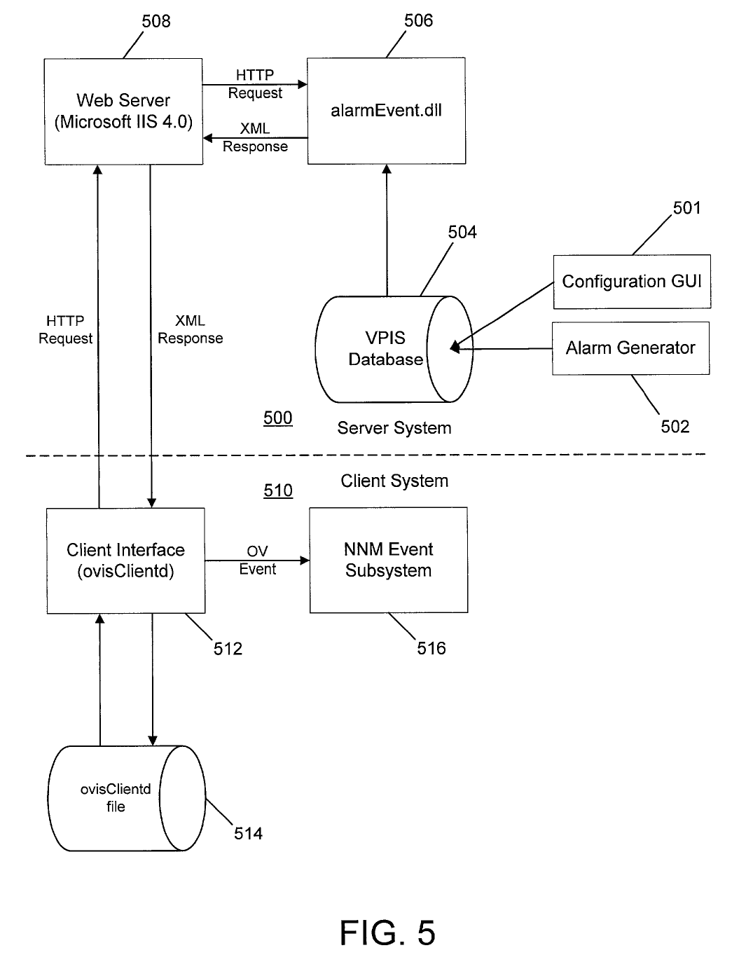

Referring to FIG. 5, a block diagram of another exemplary system of the present invention is shown. A user can configure the system via configuration graphical user interface (GUI) 501. Those skilled in the art will appreciate that GUIs are well known in the art. The GUI passes the appropriate configuration selection to the server's database 504, for example, Hewlett-Packard's Openview Vanatage Point Internet Services (VPIS). Additionally, alarm generator 502 generates an appropriate message whenever an event (i.e., an SLO violation, a configuration change, and the like) and the event data is stored into database 504. Those skilled in the art will appreciate that the database 504 can be integrated into the server 500 or stored at a remote server. AlarmEvent.dll 506 operates as a data interface to the VPIS database 504. Data requests received by the alarmEvent.dll 506 are in HTTP format. The alarmEvent.dll 506 retrieves the desired data (e.g., event data) from the VPIS database 504 and converts the data into an XML format. The XML data is then passed to web server 508 (e.g., Microsoft Internet Information Server (IIS) 4.0). The web server 508 transmits the XML data to client interface 512 (e.g., ovisClientd). The web server 508 also acts as a conduit to receive the HTTP requests and relays the HTTP request to the alarmEvent.dll 506. On the client system 510, ovisClientd 512 (i.e., the client interface) generates the HTTP data requests and transmits the requests to the web server 508. The ovisClientd 512 is a daemon process that continually polls the server for VPIS alarms and VPIS configuration data. The ovisClientd 512 also receives the XML data from web server 508 and parses the XML event data to VPIS events that can be used by the client software (e.g., Network Node Manager (NNM) Event Subsystem). Network Node Manager by Hewlett-Packard is exemplary client software that allows for the monitoring of all aspects of network parameters. A further description of the invention will use the specific names (i.e., NNM, VPIS, etc.) in describing additional aspects of the present invention

When NNM is started two processes are started, “ovisEventd” and “ovisClientd”. The ovisClientd polls the VPIS database using HTTP requests. The ovisClientd polls for any events that occurred since it's last poll, thus, any events that occurred and were stored in the VPIS database while NNM was down are not lost. Therefore, this model is more reliable than simple SNMP traps since the traps are lost if the data is transmitted when the client is down.

The ovisEventd process is configured to receive all data events. This configuration is specified via a configuration file. This file tells ovisEventd what to do when it receives an event. The default behavior for a Internet Services SLO violation event is to store the following commands into a local database for the following process to be performed:

(a) set the status source on the target node (where the service is running) to compound propagated. Normally, nodes determine their status from the interfaces on the node. Changing the status source to compound will cause the node to use the status of all of it's child objects to determine it's status.

(b) set the appropriate service capability to true. For example, if this SLO is for DNS, then we know that the target node is a DNS server and so we set the DNS server capability to true.

(c) create a symbol representing the service as a child of the target node.

The name of the symbol is the “service name:node name”. For example, if we receive a DNS SLO violation for the node “mynode.domain.com” then we will create a symbol underneath “mynode.domain.com” and name that symbol “DNS mynode.domain.com”.

(d) set the capability field to true on the service symbol “service name:node name”. This allows us to identify all objects and symbols created on behalf of Internet Services.

(e) set the status source of the service symbol to compound propagated.

(f) create a symbol representing the SLO as a child of the service symbol. The name of the symbol is “objective:service name:node name”. For example, if the SLO represents a violation of the response time metric for DNS on the node “mynode.domain.com” then we will create a symbol underneath “DNS:mynode.domain.com” and name that symbol “RESPONSE TIME:DNS:mynode.domain.com”.

(g) set the status of the SLO symbol to the severity of the alarm.

(h) set the capability field to true on the SLO symbol.

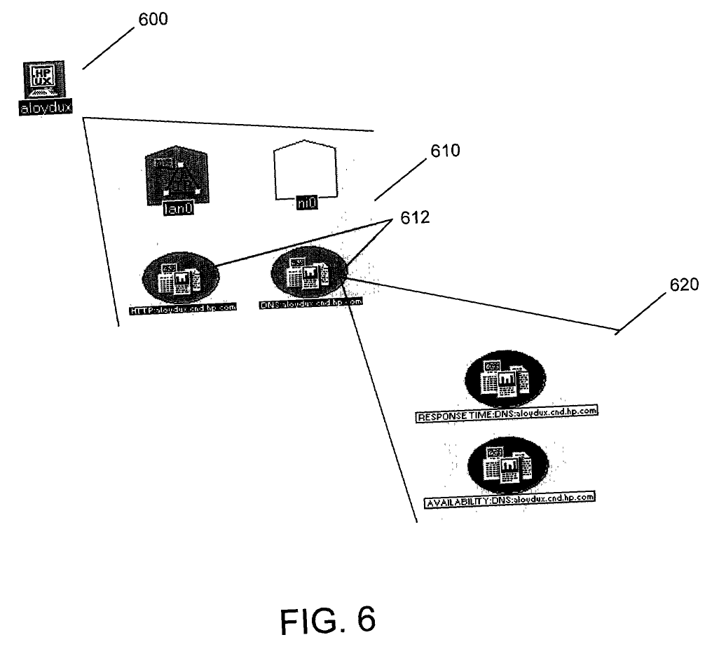

As shown in FIG. 6, the result of the above process is that the target node symbol 600 will have a child sub-map 610 which displays it's interfaces and symbols 612 representing it's services. Each of the service symbols 612 can have a child sub-map 620 that displays SLOs configured for that service. Therefore, a network administrator can view a graphical representation of the event data (e.g., alarm) generated by the server and retrieved by the client.

Although only a few elements (e.g., sequence number, creation time-stamp) in the data retrieved have been discussed up to this point, the event data can include a variety of elements that provide valuable information. For example, a VPIS probes a target (e.g., web server) and measures various metrics (e.g., availability, response time, etc). An alarm is generated when a defined metric objective is violated. For instance an objective can be: “availability for web server xyz must be greater than 90%.” The alarm (i.e., event data) can contain various elements such as hostname, associated customer information, alarm text, and the like. The following table shows an XML document type declaration (DTD) as an example of an alarm format and the VPIS mapping to the XML Alarm format.

TABLE 1
<?xml version=“1.0” ?>
<!-- @version: -->
<!DOCTYPE ALARMS [
<!ELEMENT ALARMS (ALARM*)>
<!ATTLIST ALARMS tc CDATA #REQUIRED>
<!ATTLIST ALARMS cfgts CDATA #REQUIRED>
<!ELEMENT ALARM (#PCDATA | HS | IP | PS | PN | CU | SEV | MN |
OBJ | CON | TT)*>
<!ATTLIST ALARM ts CDATA #REQUIRED>
<!ATTLIST ALARM sn CDATA #REQUIRED>
<!ELEMENT HS (#PCDATA)>
<!ELEMENT IP (#PCDATA)>
<!ELEMENT PS (#PCDATA)>
<!ELEMENT PN (#PCDATA)>
<!ELEMENT CU (#PCDATA)>
<!ELEMENT SEV (#PCDATA)>
<!ELEMENT MN (#PCDATA)>
<!ELEMENT OBJ (#PCDATA)>
<!ELEMENT CON (#PCDATA)>
<!ELEMENT TT (#PCDATA)>
]>

The following list provides a description of the terms used in Table 1, wherein:

tc is a time-stamp of the database creation;

cfgts is a time-stamp of the last configuration update;

ts is the time-stamp of when the alarm was generated;

sn is the sequence number of alarm;

HS is a Hostname of target where alarm occurred;

IP is an IP-Address of target where alarm occurred;

PS is a Probe system (host probing target system);

PN is a Probe name (e.g., HTTP, FTP, etc.);

CU is a Customer name associated with this alarm;

SEV is a Severity of the alarm given as:

| | |
|---|---|
| UNCHANGED | (0) |
| NORMAL | (8) |
| WARNING | (16) |
| CRITICAL | (32) |
| MINOR | (64) |
| MAJOR | (128); |

MN is a Metric name;

OBJ is an Objective identifier;

CON is a Condition string;

TT is Target information; and

Alarm text.

Table 2 provides an example of the XML Alarm format with appropriate information for each element.

TABLE 2

<?xml version=“1.0” ?>
<!-- @version: -->
<ALARMS tc=“984604360” cfgts=“984605519”>
<ALARM ts=“984604360” sn=“0”>
<HS>ros51328tst.hp.com</HS>
<IP/>
<PS>ros84604hae.hp.com</PS>
<PN>HTTP</PN>
<CU>Customer 1</CU>
<SEV>32</SEV>
<MN>AVAILABILITY</MN>
<OBJ>41</OBJ>
<CON>> 90.000</CON>
<TT>ros51328tst.hp.com/index.html</TT>
HTTP Service for ros51328tst.hp.com is unavailable
</ALARM>
<ALARM ts=“984604888” sn=“1”>
<HS>1.2.3.4</HS>
<IP>1.2.3.4</IP>
<PS>ros84604hae.hp.com</PS>
<PN>DNS</PN>
<CU>Customer 2</CU>
<SEV>32</SEV>
<MN>AVAILABILITY</MN>
<OBJ>3</OBJ>
<CON>> 90.000</CON>
<TT>foo@1.2.3.4</TT>
DNS Service for foo@1.2.3.4 is unavailable
</ALARM>
</ALARMS>

The foregoing has described principles, preferred embodiments and modes of operation of the invention. However, the invention is not limited to the particular embodiments discussed above. Therefore, the above-described embodiments should be regarded as illustrative rather than restrictive, and it should be appreciated that variations may be made in those embodiments by those skilled in the art, without departing from the scope of the invention as defined by the following claims.

What is claimed is:

1. A method of automated event polling in a network comprising:
logging data into a database on a server;
receiving a request for the data generated by a client using a Hypertext Transfer Protocol (HTTP) message;
responding to the request by reformatting the data into an Extensible Markup Language (XML) format; and
transmitting the data in XML format to the client.

2. The method of claim 1, wherein the data in XML format is transmitted by a web server to a client interface, wherein the client interface generates the request for the data which is received by the web server.

3. The method of claim 2, wherein the data is reformatted to XML format by a data interface, and wherein the data interface retrieves the data from the database.

4. The method of claim 3, wherein the data interface is implemented as at least one of Common Gateway Interface (CGI), Java Servlet, and Microsoft Internet Server Application Programming Interface (ISAPI)

5. The method of claim 1, wherein the data is logged into the database by an information source.

6. The method of claim 5, wherein the information source comprises:
an alarm generator; and
a configuration graphical user interface.

7. The method of claim 1, further comprising:
receiving the transmitted response by the client; and
parsing the data in XML format to obtain at least one element included in the data.

8. The method of claim 1, wherein the data includes a sequence number.

9. The method of claim 1, wherein the data includes a creation time-stamp of the database.

10. A method of event polling in a network on a client comprising:
generating a HTTP request for data from a database on a server;
receiving a response to the request in XML format; and
converting the data in XML format to a format used by client software.

11. The method of claim 10, further comprising:
storing a sequence number from the data to a client database; and
requesting data that corresponds to a next sequence number from the database on the server in a next HTTP request.

12. The method of claim 11, further comprising:
synchronizing the client when a received database creation time stamp does not equal a stored database creation time stamp stored in a client database or when the client database has not been initialized.

13. The method of claim 12, wherein synchronizing the client comprises:
initializing the client database if necessary; and
comparing the server database creation time-stamp to a creation time-stamp stored in the client database, wherein the sequence number is set to zero and the creation time-stamp stored in the client database is set to the server database creation time-stamp, if the time-stamps are not equal.

14. The method of claim 10, wherein converting the data comprises:
parsing the data in XML format to obtain at least one element contained in the data.

15. A system for automated event polling in a network comprising:
a computer-based server comprising:
logic that receives a HTTP request for data from a database on the server;
logic that responds to the request by reformatting the data into an XML format; and
logic that transmits the data in XML format; and
a computer-based client comprising:
logic that generates the HTTP request for the data from the database on the server;
logic that receives the data transmitted from the server in XML format; and
logic that converts the data in XML format to a format used by client software.

16. The system of claim 15, wherein the computer-based client further comprises:
logic that stores a sequence number from the data to a client database; and
logic that requests data that corresponds to a next sequence number from the database on the server a next in HTTP request.

17. The system of claim 15, wherein the computer-based client further comprises:
logic that synchronizes the client when a received database creation time stamp does not equal a stored database creation time stamp stored in a client database or when the client database has not been initialized.

18. The system of claim 17, wherein the logic that synchronizes the client comprises:
logic that initializes the client database if necessary; and
logic that compares the creation time-stamps, wherein the sequence number is set to zero and the creation time-stamp stored in the client database is set to the server database creation time-stamp, if the time-stamps are not equal.

19. The system of claim 15, further comprising:
an information source that logs the data to the database on the server.

20. The system of claim 19, wherein the information source comprises:
an alarm generator; and
a configuration graphical user interface.
